(19) United States
(12) Patent Application Publication
(10) Pub. No.: US 2012/0315528 A1
(43) Pub. Date: Dec. 13, 2012

(54) INTEGRATED COOLING, SEALING AND STRUCTURAL BATTERY TRAY FOR A VEHICLE

(75) Inventors: Rick RAJAIE, Rochester Hills, MI (US); Wade Bridges, Bloomfield, MI (US); Amandeep Bains, Canton, MI (US); Rainer Schulz, Birmingham, MI (US); Thomas Fritz, Ann Arbor, MI (US); Paul E. Boskovitch, Costa Mesa, CA (US); Leland Decker, Auburn Hills, MI (US)

(73) Assignee: Fisker Automotive, Inc.

(21) Appl. No.: 13/344,511

(22) Filed: Jan. 5, 2012

Related U.S. Application Data
(63) Continuation of application No. PCT/US2010/041332, filed on Jul. 8, 2010.
(60) Provisional application No. 61/223,902, filed on Jul. 8, 2009.

(51) Int. Cl. B60R 16/04; H01M 10/50

(52) U.S. Cl. 429/100

(57) ABSTRACT

An integrated cooling, sealing and structural battery tray for a vehicle includes a generally planar base member having a support surface and a cooling system formed by the planar base member. A seal is formed between the battery tray and the support structure for the vehicle. The integrated cooling, sealing and structural battery tray may also include a plurality of fins are disposed on the support surface, wherein the fins are adjacent each other, and a plurality of routing apertures extending through the base member and having a plurality of cooling lines disposed therein.

### CROSS REFERENCE TO RELATED APPLICATIONS

This application claims the benefit of and priority to U.S. Provisional Application No. 61/223,902, filed Jul. 8, 2009, which is incorporated herein by reference.

### BACKGROUND

The present disclosure relates generally to a vehicle, and more particularly to an integrated cooling, sealing and structural battery tray for an electric powered vehicle.

### DESCRIPTION OF THE RELATED ART

Vehicles, such as a motor vehicle, utilize an energy source in order to provide power to operate a vehicle. While petroleum based products dominate as an energy source, alternative energy sources are available, such as methanol, ethanol, natural gas, hydrogen, electricity, solar or the like. A dedicated vehicle utilizes a single energy source, while a hybrid powered vehicle utilizes a combination of energy sources in order to power the vehicle. Such vehicles are desirable since they take advantage of the benefits of multiple fuel sources, in order to enhance performance and range characteristics of the hybrid vehicle relative to a comparable gasoline powered vehicle.

An example of a hybrid vehicle is a vehicle that utilizes electric and solar energy as a power source. Solar energy is readily available, but may not be sufficient by itself to operate the vehicle. An electric vehicle is environmentally advantageous due to its low emissions characteristics and general availability of electricity as a power source. However, battery storage capacity limits the performance of the electric vehicle relative to a comparable gasoline powered vehicle.

Various factors are optimized with respect to the battery. The physical size of the battery increases with storage capacity. It may be difficult to package the battery in a plug-in hybrid or electric vehicle due to the physical size of the battery. In addition to packaging constraints, the structural integrity of the battery needs to be preserved in the event of the application of a force to the vehicle, such as the force of an impact. Protecting the battery itself from environmental factors, such as heat, moisture intrusion, dirt or the like is accomplished by the seal between the battery and a support structure. Further, cooling of the battery may be accomplished by conditioned air, or a coolant fluid, or a combination of conditioned air and a coolant fluid. In the past, separate structures were utilized to preserve the structural integrity of the battery, seal the battery, cool the battery and support the battery. These separate systems increased factors such as cost, assembly time, weight, and packagability. Thus, there is a need in the art for an electric powered vehicle with an improved battery tray that integrates thermal control and sealing into one structure for supporting the battery while maintaining the overall structural integrity of the battery.

### SUMMARY

Accordingly, the present disclosure relates to an integrated cooling, sealing and structural battery tray for supporting a battery in an electric powered vehicle. The battery tray includes a generally planar base member. The base member has a predetermined thickness. A plurality of fins are arranged on an upper surface of the base member. The fins are arranged to be adjacent to each other, and are spaced a predetermined distance apart. The base plate includes a plurality of apertures for routing liquid cooling lines that assist in dissipating heat from the battery. The battery tray is secured to the vehicle structure, and a sealant is applied between the conjoined members.

An advantage of the present disclosure is that a battery tray is provided that integrates cooling, sealing and structural integrity features in one unit. Another advantage of the present disclosure is that the battery tray improves packagability of the battery. Yet another advantage of the present disclosure is that the integrated battery tray reduces overall vehicle weight. A further advantage of the present disclosure is that the battery tray protects the battery housing in the event of an impact force. Still a further advantage of the present disclosure is that the battery tray seals the battery from environmental intrusion. Yet a further advantage of the present disclosure is that durability, reliability and assembly of the battery and tray are enhanced. Still yet a further advantage of the present disclosure is that recyclability is enhanced by eliminating usage of multiple materials as compared to present batteries and trays.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a hybrid vehicle, according to an exemplary embodiment.

FIG. 2 is a top view of the vehicle of FIG. 1 having an engine and battery.

FIG. 3 is a perspective view of a vehicle having a battery and tray on the vehicle substructure.

FIG. 4 is a cross-sectional view taken along line 4-4 of the battery assembly of FIG. 3.

FIG. 5 is a perspective view of a battery tray.

FIG. 6 is a perspective end view of a battery tray and cover.

FIG. 7 is an enlarged end view of a battery tray and battery assembly.

### DESCRIPTION

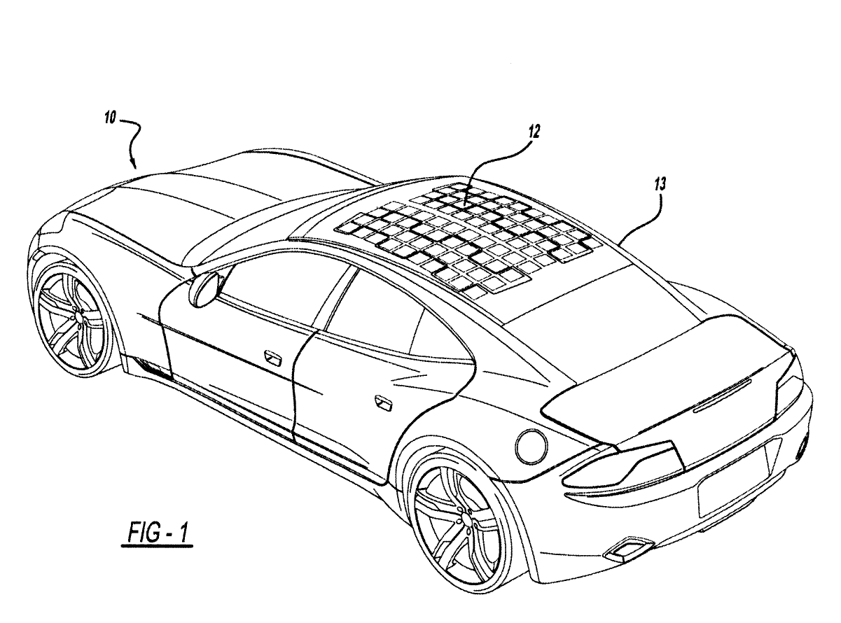

Referring generally to the FIGS. 1-7 and particularly to FIG. 1, a hybrid vehicle 10 is illustrated. In this example the vehicle 10 is a plug-in hybrid vehicle that is solar and electric powered. The vehicle 10 may be a passenger car, truck, or other type of vehicle having a battery. In another example, the vehicle 10 is a dedicated electric powered vehicle.

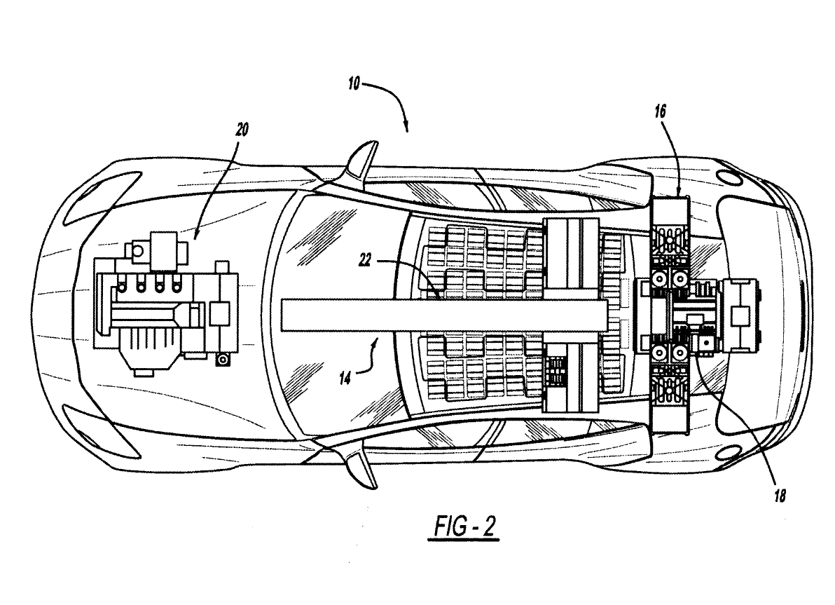

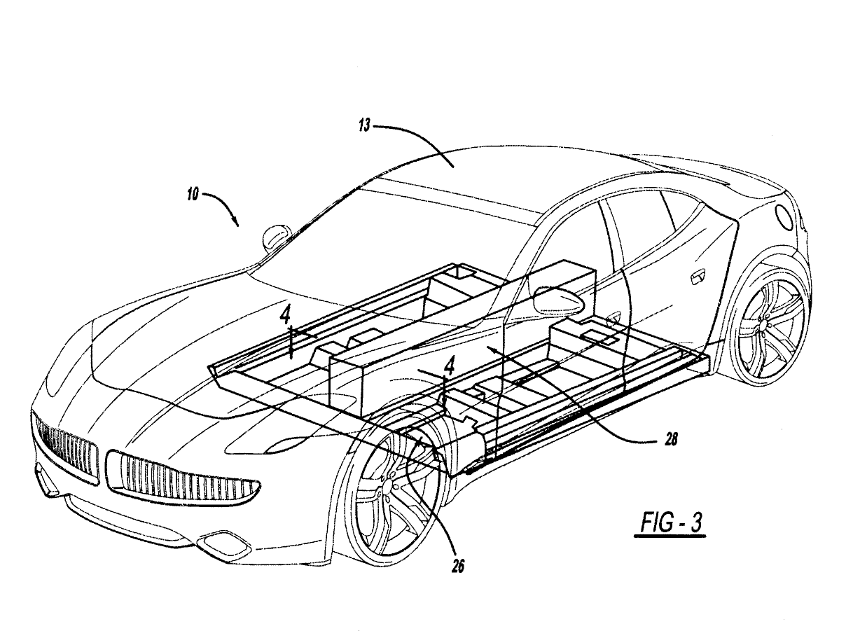

Referring now to FIG. 2, the vehicle 10 includes a power train 14 that controls the operation of the vehicle 10. In this example, the power train 14 is a plug-in hybrid, and includes an electrically powered motor 16 and motor controller 18. The vehicle 10 may also include a gasoline powered engine 20 that supplements the electric motor 16 when required under certain operating conditions. The electrical energy is stored in an energy storage device, such as the battery 22. The battery 22 may be a single unit, or a plurality of modules arranged in a predetermined manner, such as in series. Various types of batteries may be used, such as lead acid, or lithium-ion or the like. The battery 22 is contained within a battery case 24 and coupled to the vehicle's frame 26, as shown in FIG. 3. Various strategies are available to cool the battery 22, such as the circulation of conditioned air or a fluid in or around the battery case 24.

It should be appreciated that the vehicle 10 may include more than one type of battery 22 or energy storage device. The battery 22 supplies the power in the form of electricity to operate various vehicle components. In this example, there is a low voltage battery 22a that provides electrical power to vehicle components and a high voltage battery (i.e. 400 V traction battery) 22b that provides electrical power to an electric drive motor 16. The battery 22 may be in communication with a control system that regulates the distribution of power within the vehicle 10, such as to the electric drive motor 16, or a vehicle component or other accessories or the like. In this example, the high voltage battery 22b receives electrical energy from a plug-in source, and the low voltage battery 22a receives electrical energy from a solar source, such as the solar panel 12, or the like. Battery assembly 28 is supported within the vehicle 10 in a manner to be described.

In this example, the vehicle 10 includes a secondary power source, such as a solar panel 12 positioned on an outer surface 13 of the vehicle 10, so as to receive radiant energy from the sun. In another example, the vehicle 10 could include a different secondary energy source. The solar panel 12 of this example is operable to collect radiant energy from the sun and convert the sun's energy into stored electrical energy. This solar energy is available to supplement that of the primary electric energy source. The supplemental energy source effectively increases the performance of the vehicle 10, i.e. increased electric range or use for an accessory such as climate control or the like.

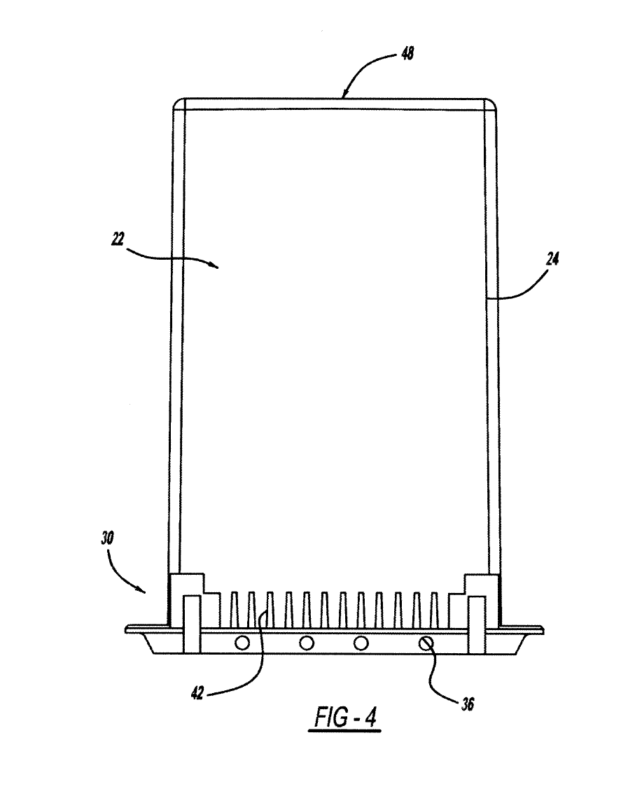

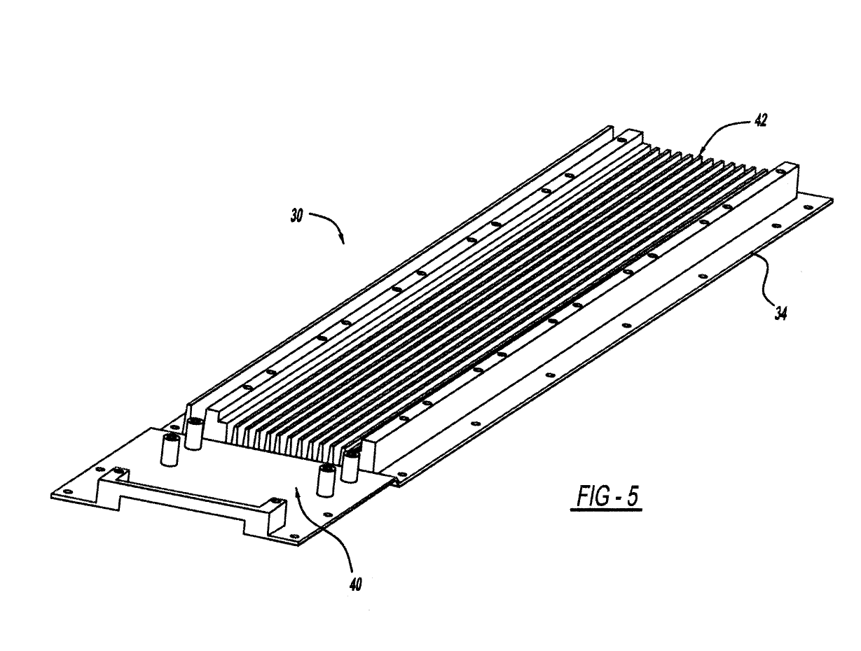

The battery 22 is supported within the vehicle by a battery tray 26, as shown in FIG. 4. In this example, the battery 18 and battery tray 30 extend longitudinally along the length of the vehicle 10. The battery tray 30 is fabricated from a metal material, such as Aluminum or the like. The tray 30 includes a generally planar base plate 32 having a support surface 34. The dimensions of the base plate 32, such as thickness are selected to maintain the structural integrity of the battery 22 in the event of a force applied to the battery 22, such as the force of an impact. The base plate 32 includes a plurality of strategically placed routing apertures 36 that receive cooling lines 38 therethrough that assist in the dissipation of heat as part of the thermal management system for the battery 22. A front portion of the tray shown at 40 directs air over the fins 42 in a manner to be described, as shown in FIG. 5. It may also provide for routing of wires and connectors for the battery 22.

In this example, the battery tray 30 also includes a plurality of fins 42 arranged on the support surface of the base plate 34, and perpendicular thereto. The number and arrangement of the fins 42 on the base plate 32 are selectively determined to provide a pathway for the transfer of heat away from the battery 22 in a manner to be described.

Also in this example, the battery tray 30 is secured to the vehicle frame 26 using a fastener, such as a bolt. A seal 44 is applied between a flange portion 46 of the base member 32 and the vehicle frame 26 to prevent the intrusion of elements such as moisture or dirt or like into the interior of the battery 22, An example is a sealant is rubber or foam or adhesive, or the like.

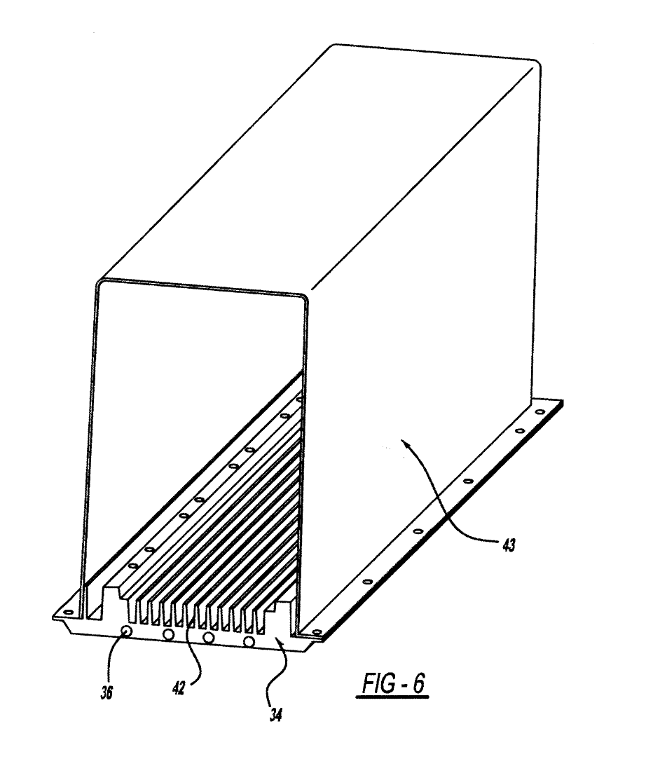

The battery tray 30 further includes a removable housing 48 secured to the tray 30, as shown in FIG. 6. The housing 48 is a generally box-like structure that provides additional protection to the battery 22. The housing 48 is secured to the battery tray 30, such as using a fastener.

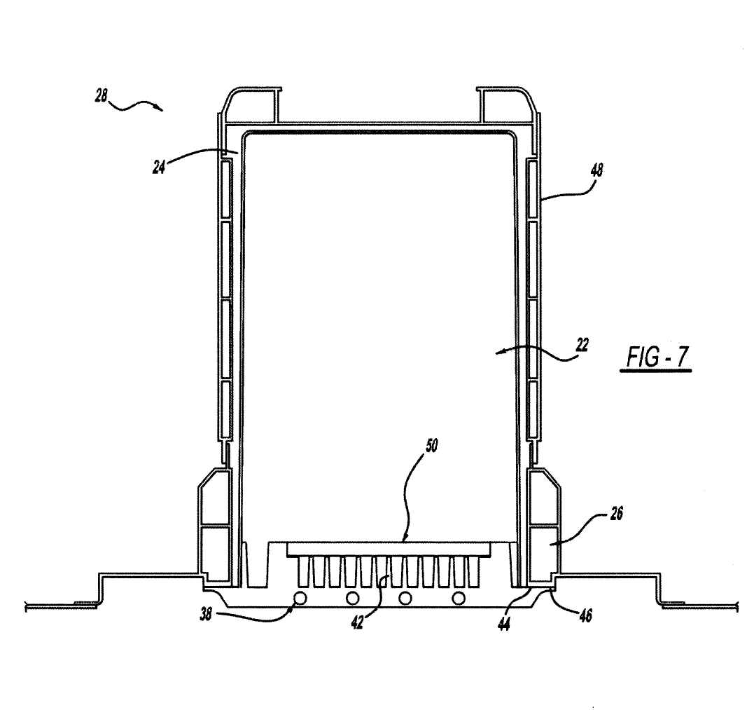

Referring now to FIG. 7, the thermal management of the battery 22 is accomplished using one or more fluids, such as, air, liquid coolant, or the like. In this example, the thermal management of the battery 22 is accomplished using air as well as a liquid coolant. The coolant lines 38 are positioned below the battery tray 30 and extend the length of the battery tray 30. A coolant fluid, such as a water glycol mixture travels through the coolant lines 38, and heat is transferred from the battery 22, including surrounding the battery housing 48 or battery case 24 to the coolant fluid and away from the battery 22. The coolant fluid path is selected to reduce any risk of battery cell failure. The conditioned air also travels throughout the assembly 28, such as within the battery case 24 or housing 48 or between the battery case 24 and housing 48 along a predetermined path in order to cool the interior portion of the battery 22. The conditioned air is provided via a dedicated heat exchanger, such as a liquid refrigerant or air/liquid heat exchanger. Another example is an auxiliary coolant heater. The conditioned air enters the battery assembly 28 via a plenum 50 or chamber, and exits the battery assembly 28 in a similar manner. The plenum 50 may be part of the tray 30 or part of an air flow line. In this example, the plenum 50 is positioned on top of the fins 42. The fins 42 direct the flow path of the conditioned air into a plenum 50 to circulate air around the battery case 24 to cool the interior of the battery 22. A plurality of fans located within the battery case 24 also circulates the air within the battery case 24 to insure uniform temperature distribution within the interior of the battery 22, and especially the cells. The air exiting the battery 22 is recirculated back through the heat exchanger, and cooled.

In this manner, the battery tray 30 serves as both a coolant path and a structural element that supports and protects the battery 22. The tray 30 seals the battery 22 and further protects the battery 22 from environmental effects of moisture, debris or dirt or the like. The integrated battery tray assembly 28 combines cooling, structural and sealing features into one component.

The hybrid vehicle 10 may include other features conventionally known for a vehicle, such as a gasoline motor, other controllers, a drive train or the like.

It is also contemplated that the integrated battery tray 30 can include a cooling system functioning on air only, coolant only, air and coolant, or the like. Moreover, it is contemplated that the integrated battery tray can include and/or exclude certain features, such as fins, coolant lines, air flow line, plenum, or the like, depending on the type of cooling system included.

Many modifications and variations of the present disclosure are possible in light of the above teachings. Therefore, within the scope of the appended claim, the present disclosure may be practiced other than as specifically described.

What is claimed is:

1. A battery tray for a vehicle, the battery tray comprising:
a generally planar base member having a support surface and a cooling channel formed in the base member;
a plurality of fins disposed on the support surface;
a seal formed between the base member and a support structure of the vehicle; and
a removeable housing coupled to the base member for housing a battery.

2. The battery tray of claim 1, wherein the fins are adjacent each other.

3. The battery tray of claim 1, the cooling channel comprising a plurality of cooling lines extending through the base member.

4. The battery tray of claim 1, the battery tray having a front portion that directs air over the fins.

5. The battery tray of claim 1, wherein the seal is a flange portion of the base member that forms a seal with the support structure of the vehicle.

6. The battery tray of claim 1, further comprising:
a plenum positioned above the support surface to circulate air within the housing.

7. The battery tray of claim 1, further comprising:
one or more fans arranged within the housing.

8. A battery tray for a vehicle, the battery tray comprising:
a generally planar base member having a support surface;
a plurality of fins disposed on the support surface, wherein the fins are adjacent each other;
a seal formed between the base member and a support structure of the vehicle;
a cooling channel formed in the base member;
a plurality of cooling lines disposed within the cooling channel; and
a removeable housing coupled to the base member for housing a battery.

9. The battery tray of claim 8, the battery tray having a front portion that directs air over the fins.

10. The battery tray of claim 8, wherein the seal is a flange portion in the base member that forms a seal with the support structure of the vehicle.

11. The battery tray of claim 8, further comprising:
a plenum positioned above the support surface to circulate air within the housing.

12. The battery tray of claim 8, further comprising:
one or more fans arranged within the housing.
